(19) United States
(12) Patent Application Publication
(10) Pub. No.: US 2026/0052379 A1
(43) Pub. Date: Feb. 19, 2026

(54) VENDOR SPECIFIC PHYSICAL LAYER PRIVACY ENHANCEMENTS

(71) Applicant: Cisco Technology, Inc., San Jose, CA (US)

(72) Inventors: Domenico FICARA, Essertines-Sur-Yverdon (CH); Brian D. HART, Sunnyvale, CA (US); Jerome HENRY, Pittsboro, NC (US)

(21) Appl. No.: 18/806,567

(22) Filed: Aug. 15, 2024

(51) Int. Cl. H04W 12/02; H04W 12/033; H04W 84/12

(52) U.S. Cl. CPC H04W 12/02; H04W 12/033; H04W 84/12

(57) ABSTRACT

The present disclosure provides techniques to enhance privacy and security for wireless communications involving vendor-specific physical layer (PHY) extensions. A client device generates an obfuscated vendor identifier (ID) by applying one or more transformation functions to a real vendor ID. The client device generates an encrypted message, where the encrypted message comprises obfuscation data, which, when used, converts the obfuscated vendor ID into the real vendor ID. The client device transmits the encrypted message to an access point (AP). The client device transmits a data packet containing the obfuscated vendor ID to the AP.

### TECHNICAL FIELD

Embodiments presented in this disclosure generally relate to wireless communication. More specifically, embodiments disclosed herein relate to methods of obfuscating vendor-specific physical layer (PHY) parameters to prevent unauthorized device tracking.

### BACKGROUND

With the proposed introduction of explicitly and compliantly signaled vendor-specific physical layer (PHY) extensions in ultra-high reliability (UHR) wireless communication, there arises an additional security concern regarding the potential for information leakage that may facilitate unauthorized tracking of client devices. Specifically, an attacker that intercepts wireless traffic may observe that a media access control (MAC) address is using a particular vendor-specific PHY extension. After a defined period has passed, the attacker may then notice that a newly generated MAC address is using the same vendor-specific PHY extension as the initial one, even though the original MAC address has changed. Based on the observation, the attacker may speculate that the two MAC addresses could be linked to the same device or user. Using this correlation, the attacker may then track the movements or usage pattern of the device, despite changes in its MAC address. Such unauthorized tracking violates the privacy requirements set forth in the IEEE 802.11bi amendment.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example ESS configuration with an external interception threat, according to some embodiments of the present disclosure.

FIG. 2 depicts an example of a physical layer protocol data unit (PPDU) structure supporting UHR communication, according to some embodiments of the present disclosure.

FIG. 3 depicts an example sequence of message exchanges for obfuscating vendor IDs and managing collisions across basic service sets (BSSs), according to some embodiments of the present disclosure.

FIG. 4 depicts an example sequence of message exchanges for generating and utilizing a burner MAC address in vendor-specific PHY communications, according to some embodiments of the present disclosure.

FIG. 5 depicts an example sequence of message exchanges for using dual basic service set identifiers (BSSIDs) in vendor-specific PHY communications, according to some embodiments of the present disclosure.

FIG. 6 depicts an example method for a station (STA) to obfuscate and validate vendor IDs within an extended service set (ESS), according to some embodiments of the present disclosure.

FIG. 7 depicts an example method for an access point (AP) to coordinate obfuscated vendor IDs within an ESS, according to some embodiments of the present disclosure.

FIG. 8 is a flow diagram depicting an example method for vendor ID obfuscation and coordination to avoid unauthorized tracking, according to some embodiments of the present disclosure.

FIG. 9 depicts an example network device configured to perform various aspects of the present disclosure, according to some aspects of the present disclosure.

FIG. 10 depicts an example client device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, generating, by a client device, an obfuscated vendor identifier (ID) by applying one or more transformation functions to a real vendor ID, generating, by the client device, an encrypted message, where the encrypted message comprises obfuscation data, which, when used, converts the obfuscated vendor ID into the real vendor ID, transmitting, by the client device, the encrypted message to an access point (AP), and transmitting, by the client device, a data packet containing the obfuscated vendor ID to the AP.

Other embodiments in this disclosure provide one or more non-transitory computer-readable media containing, in any combination, computer program code that, when executed by operation of a computer system, performs operations in accordance with one or more of the above methods, as well as a system of a client device comprising one or more computer processors, and one or more memories collectively containing one or more programs, which, when executed by the one or more computer processors, perform operations in accordance with one or more of the above methods.

### EXAMPLE EMBODIMENTS

The inclusion of a vendor-specific PHY extension within UHR data packets has recently been proposed. This extension may include information such as the sending device's vendor ID and relevant proprietary optimization parameters. With this information, the receiving device can learn the sending device's vendor-specific capabilities and requirements, and adaptively adjust its local configurations, such as modifying the behavior of the AP receiver in processing the data from associated STAs to optimize communication quality.

However, the inclusion of vendor-specific PHY extensions also raises security concerns, particularly regarding unauthorized device tracking. When these extensions are utilized, they may inadvertently expose unique patterns or identifiers that can be exploited by malicious actors. For example, when an attacker intercepts traffic where a dynamic MAC address is generated to conceal the device's identity, the attacker may notice that packets with different MAC addresses contain the same vendor-specific PHY parameters. By correlating this information, the attacker may infer that these packets originate from the same device, even though they contain different MAC addresses. The attacker may then use the vendor-specific PHY parameters to track the device's usage and/or movements over time across different networks.

Embodiments of the present disclosure introduce techniques to enhance privacy and security for wireless communications involving vendor-specific PHY extensions. In one embodiment, the real vendor ID may be obfuscated using predefined transformation algorithms or cryptographic techniques. The device may send the mapping or cryptographic key to the receiving device in a separate encrypted message. In this configuration, an attacker intercepting the traffic between the sending device and receiving device is not aware of the real vendor ID unless it decrypts the separate encrypted message. In embodiments where the sending device is within an ESS that comprises multiple overlapping BSSs, the obfuscated vendor ID may be coordinated across BSSs to ensure its uniqueness.

In one embodiment, the sending device may generate a temporary burner (e.g., disposable) MAC address specifically for communications involving vendor-specific PHY extensions. For other communications without such extensions, the sending device may use its hardware MAC address (e.g., the address that is permanently assigned to the device's network interface) or an identifiable random MAC (IRM) address generated at each epoch. Such separation may ensure that an attacker intercepting the traffic cannot link the burner MAC address used for vendor-specific communications to the device's hardware or IRM address used to regular communications, further protecting the device's identity against unauthorized tracking.

In one embodiment, the network may allocate each AP within the ESS to two distinct BSSIDs, one for regular data communications that do not involve vendor-specific PHY extensions, and another for communications with such extensions. An attacker intercepting the traffic may observe packets with the same MAC address having different BSSIDs, making it more difficult to correlate these packets to the same device.

By implementing methods such as dynamically renewing obfuscated vendor IDs at regular epochs, generating temporary burner MAC addresses for vendor-specific communications, and using dual BSSIDs to separate different types of network traffic, the device may remain anonymous during its interactions within the network. As such, the disclosed embodiments effectively protect user privacy and therefore prevent unauthorized device tracking.

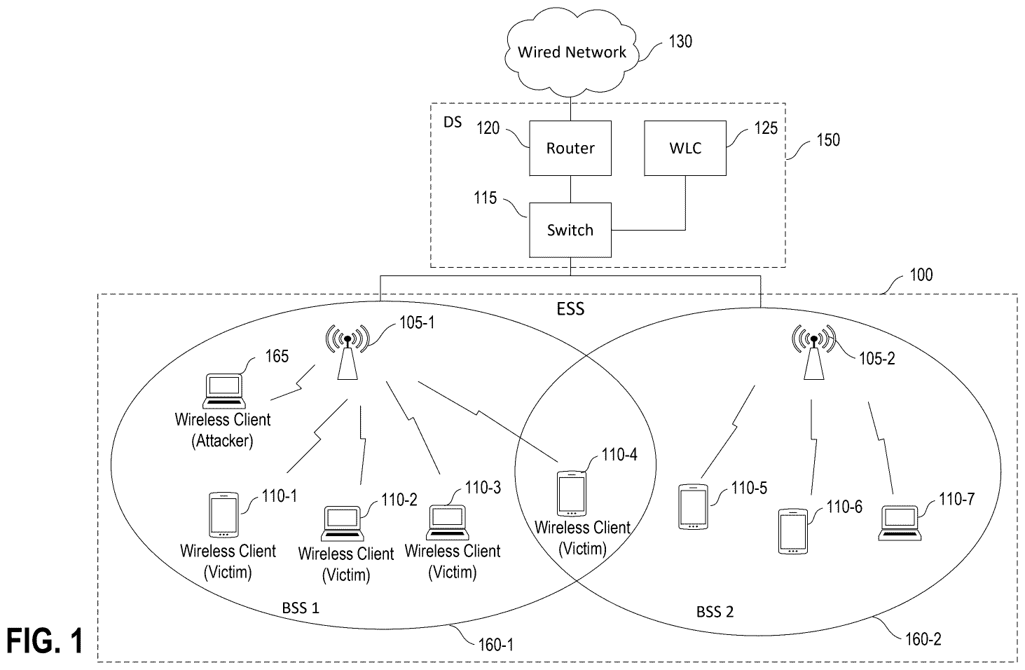

FIG. 1 depicts an example ESS configuration 100 with an external interception threat 165, according to some embodiments of the present disclosure.

As depicted, the example ESS 100 includes two basic service sets (BSSs): BSS 1 (160-1) and BSS 2 (160-2). Each BSS 160 includes an AP 105 and its associated STAs 110. For example, BSS 1 includes AP 105-1 and STA 110-1, STA 110-2, STA 110-3, and STA 110-4. BSS 2 includes AP 105-2 and STA 110-5, STA 10-6, and STA 110-7. The two BSSs 160 are interconnected by a distributed system (DS) 150, which comprises a switch 115, a router 120, and a wireless controller (WLC) 125. Through the DS 150, each STA 110 is connected to the wired network 130, and is capable of receiving and sending data from/to the network. In some embodiments, the wired network 130 may be a local network (LAN) (e.g., an enterprise network), or a wide area network (WAN) (e.g., the Internet).

In some embodiments, the example ESS architecture 100 may be applied in large buildings, campuses, or enterprise environments. When users are moving within these environments (e.g., ESS 100), their devices (e.g., STAs 110) may roam across different BSSs 160 within the same ESS 100 while maintaining their network connection. For example, STA 110-4, which is located within the overlapping area of BSS 1 (160-1) and BSS 2 (160-2), may disassociate from AP 105-1 and reassociate with AP 105-2 as it moves closer to AP 105-2. The roaming process across BSSs 160 may provide continuous connectivity and an uninterrupted user experience.

In some embodiments, the ESS 100 may work as a single network with a common service set identifier (SSID) that STAs 110 recognize and connect to. Each BSS 160 may operate on a specific channel, and be identified by a unique basic service set identifier (BSSID). In some embodiments, the BSSID may correspond to the MAC address of the AP 105. In some embodiments, the BSSID may be included within the MAC header of data packets (e.g., physical layer protocol data units (PPDUs)) transmitted between the devices within the network.

In some embodiments, each STA 110 may be identified by its burned-in or hardware MAC address (e.g., the address that is permanently assigned to the device at the time of manufacturing) or by an IRM address (e.g., the address that is generated randomly each epoch for establishing an association link). In some embodiments, the MAC address may be included within the MAC header of data packets (e.g., PPDUs) transmitted between the devices within the network.

As illustrated, the wireless client device 165, acting as an attacker, is within the range of BSS 1 (160-1). In some embodiments, the attacker 165 may intercept data transmitted between AP 105-1 and the associated STAs, such as STA 110-1, STA 110-2, STA 110-3, and STA 110-4. For example, when the attacker 165 intercepts a data packet from STA 110-1 to AP 105-1, the attacker may analyze the packet's MAC header to identify the BSSID of BSS 1 (e.g., the MAC address of AP 105-1) and the MAC address of the sending device, STA 110-1. Since the MAC address used in UHR communications is typically an IRM address generated randomly each epoch, the attacker 165 cannot track the device's movements and/or usage patterns solely based on the MAC address, as it changes periodically. As used herein, an epoch may refer to a defined period of time during which the IRM address remains valid. After the period expires, a new IRM address is generated and starts a new epoch.

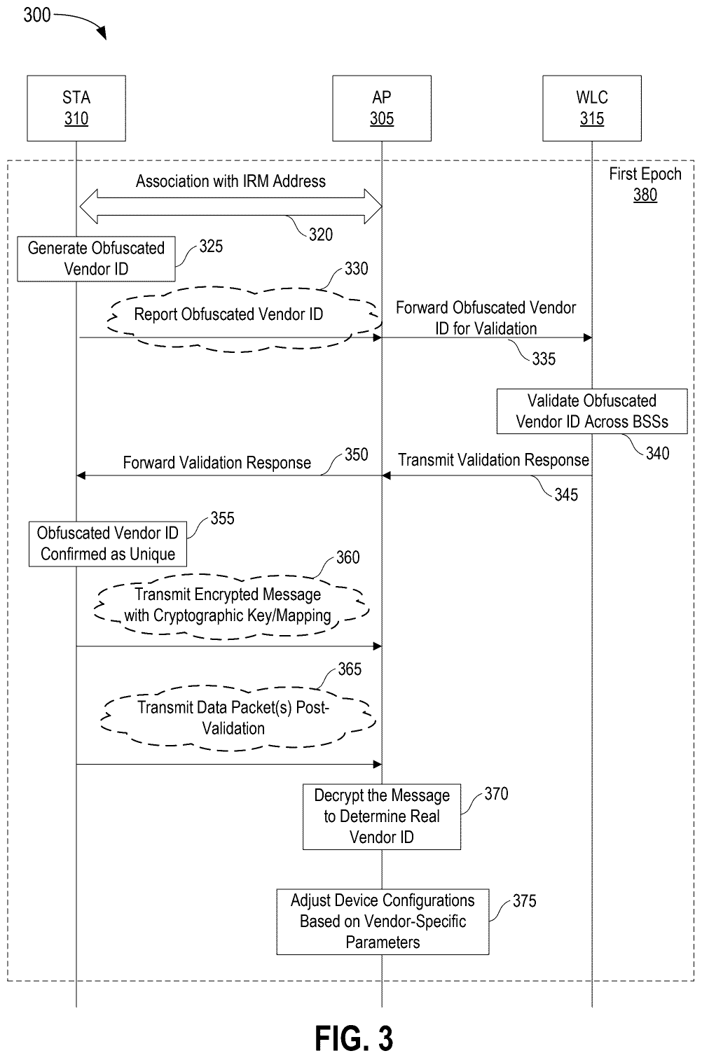

However, when a vendor-specific PHY extension is included within the packet (e.g., PPDU), the extension may contain unique vendor IDs and/or relevant parameters specific to the vendor's hardware or communication protocols. These vendor-specific PHY parameters may remain consistent across different epochs, even if the MAC address changes. By analyzing the intercepted traffic, the attacker 165 may identify packets that, although having different MAC addresses, contain identical (or at least similar) vendor-specific PHY parameters. From this correlation, the attacker 165 may infer that these packets, despite the varying MAC addresses, originate from the same device. As a result, the attacker 165 may track the device's movements and/or usage patterns by continuously monitoring the vendor-specific PHY parameters, ignoring the periodic changes in the MAC address. To prevent such unauthorized tracking, measures to further protect user privacy and improve communication security are desired, such as obfuscating vendor-specific parameters at regular epochs, generating temporary burner (e.g., disposable) MAC addresses for communications involving vendor-specific PHY extensions, or using dual BSSIDs to distinguish between regular data communications and those involving vendor-specific PHY extensions. More detail is discussed below with reference to FIGS. 3-7.

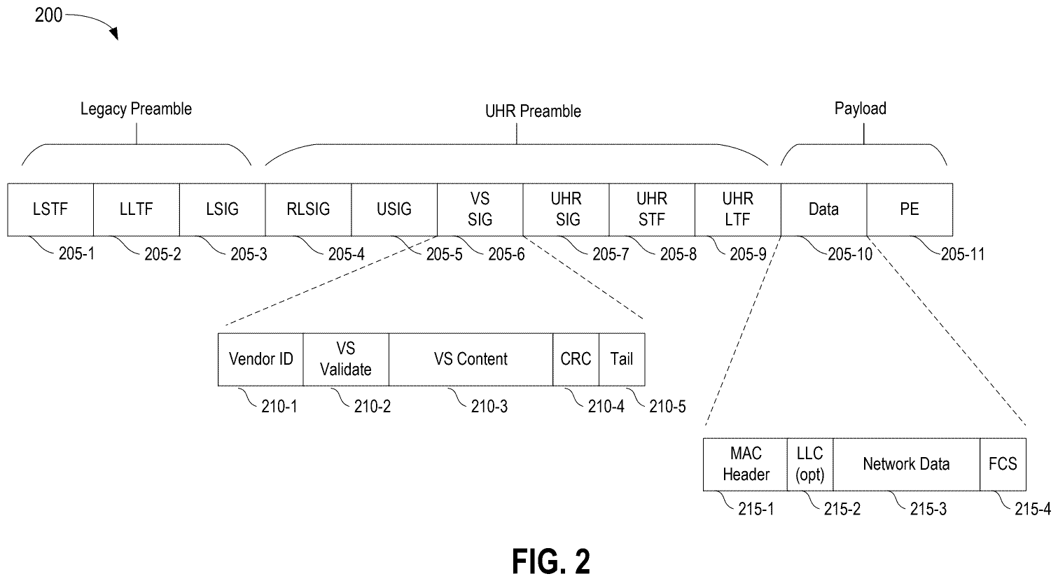

FIG. 2 depicts an example of a PPDU structure 200 supporting vendor-specific PHY signaling in UHR communications, according to some embodiments of the present disclosure.

The PPDU (also referred to in some embodiments as a data packet) typically includes preamble fields and data fields. The preamble fields contain the transmission vector format information, and the data fields contain the user payload and higher layer headers (e.g., MAC header). The transmission vector format and the PPDU structure may vary between 802.11 versions.

FIG. 2 depicts an example PPDU structure 200 that supports vendor-specific PHY signaling. The example PPDU 200 includes nine preamble fields, each with a specific function. In some embodiments, the legacy short training field (LSTF) 205-1 may be used for packet detection and coarse synchronization. The legacy long training field (LLTF) 205-2 may be used for channel estimation and fine synchronization, and the legacy signal field (LSIG) 205-3 may provide data about the length of the PPDU and other transmission parameters. As illustrated, the LSTF 205-1, LLTF 205-2, and LSIG 205-3 form the legacy preamble within the PPDU 200.

In some embodiments, the revised legacy signal field (RLSIG) 205-4 may is used for LSIG decoding enhancement and may assist with PHY format detection. The UHR signal field (USIG) 205-5 may be used to indicate the presence of the vendor-specific signal field (VS-SIG) 205-6 (also referred to in some embodiments as the vendor-specific PHY extension) within the PPDU 200. In some embodiments, the USIG 205-5 may use a binary indicator to demonstrate the presence or absence of a vendor-specific PHY extension. For example, “0” may indicate that no extension is present, while “1” may represent that a vendor-specific PHY is present (e.g., that the VS SIG 205-6 is utilizing modulation and coding scheme (MCS) 0 and a single orthogonal frequency-division multiplexing (OFDM) symbol, with 26 bits available for use. In some embodiments, additional numbers may be used to represent other configurations, such as “2” for VS SIG 205-6 using MCS1 with one OFDM symbol, and “3” for VS SIG 205-6 using MCS1 with two OFDM symbols, with 52 bit available for use.

In some embodiments, the VS SIG 205-6 may contain detailed vendor-specific PHY information. As depicted, the VS SIG 205-6 includes five sub-fields, including vendor ID sub-field 210-1, vendor-specific (VS) Validate sub-field 210-2, VS content sub-field 210-3, CRC 210-4, and tail 210-5. In some embodiments, the vendor ID sub-field 210-1 may provide the vendor ID that can be used to identify the company that manufactured the device. As used herein, the vendor ID may be a unique identifier assigned to each vendor (or manufacturer), allowing for the differentiation of hardware and software configurations between vendors. The vendor ID may have a defined length, like 9-bit, 16-bit, or 24-bit, with sufficient bits to encode the number of possible vendors. In some embodiments, the VS validate sub-field 210-2 may use a binary indicator to demonstrate how vendor-specific signaling should be handled by a receiving device. For example, “0” may be used to indicate that the receiving device should continue to process the PPDU whether or not the vendor-specific signaling is recognized, while “1” may be used to indicate that the receiving device should continue processing the PPDU only if the vendor-specific signaling is recognized. If the vendor-specific signaling is not recognized, the receiving device should assert that the clear channel assessment (CCA) is busy for the remainder of the PPDU. In some embodiments, the VS content sub-field 210-3 may include parameters that are specific to the vendor's hardware, software, and/or communication protocols. With these parameters, the receiving device may learn the sending device's vendor-specific requirements and capabilities, and adjust its network configurations to optimize the overall performance and compatibility. Such adjustments may include tuning the operational parameters, such as low noise amplifier (LNA) gain levels, tracking algorithms, channel smoothing algorithms, data rates, or error correction schemes, to better align with the vendor-specific enhancements. In some embodiments, the cyclic redundancy check (CRC) 210-4 may be used to verify whether the vendor-specific content has been altered or corrupted during transmission. This check may be performed to confirm data integrity within the VS SIG field 205-6. In some embodiments, the tail 210-5 may be added for bit alignment in the VS SIG field 205-6, to ensure that the data field conforms to the structure needed for efficient and reliable FEC decoding.

In some embodiments, the UHR signal field (UHR SIG) 205-7 may contain additional signaling information for UHR communications. In some embodiments, the UHR short training field (UHR STF) 205-8 may be used for AGC and/or synchronization purposes, to align the PPDU processing to the specific UHR requirements. In some embodiments, the UHR long training field (UHR LTF) 205-9 may provide information for channel estimation, to adapt the PPDU processing to the specific channel characteristics in UHR environments.

As depicted, the fields RLSIG 205-4, USIG 205-5, VS SIG 205-6, UHR SIG 205-7, UHR STF 205-8, and UHR LTF 205-9 collectively form the UHR preamble, providing additional information for UHR communications.

The payload of the PPDU includes the Data field 205-10 and the packet extension (PE) field 205-11. The Data field 205-10 further contains four sub-fields, including MAC header 215-1, logical link control (LLC) 215-2, network data 215-3, and frame check sequence (FCS) 215-4. There may be multiple instances of these within an A-MPDU. In some embodiments, the MAC header 215-1 may contain control information for data transmission, such as the source MAC address (e.g., the sending device's MAC address), the destination MAC address (e.g., the receiving device's MAC address), the BSSID (e.g., the AP's MAC address), and the like. The control information may help for bridging the data packet correctly between devices within a wireless network. In some embodiments, the LLC 215-2 may be used for frame synchronization and error checking at the data link layer. In some embodiments, the network data sub-field 215-3 may contain the actual payload data, including user data and/or higher-layer protocol information. In some embodiments, the FCS 215-4 may be used by the receiving device for integrity verification, to check if the data arrived intact and without any errors introduced during the transmission across the network.

When the example PPDU 200 sent from a STA (e.g., 110-1 of FIG. 1) to its associated AP (e.g., 105-1 of FIG. 1) is intercepted by an attacker (e.g., 165 of FIG. 1), the attacker may analyze the PPDU to extract useful information. In some embodiments, the attacker may examine the MAC header 215-1, which contains the BSSID and the MAC address of the STA (e.g., 110-1 of FIG. 1). As used herein, the BSSID may be the MAC address of the AP (e.g., 105-1 of FIG. 1) that the STA is communicating with. By identifying the BSSID, the attacker may determine the specific BSS to which the intercepted data belongs. As used herein, the MAC address may serve as the unique identifier of the STA sending the PPDU. The MAC address contained within the PPDU may be a burned-in (or hardware) MAC address, which is permanently assigned to the network interface card (NIC) of the device during its manufacturing process and remains static throughout the device's operation. By identifying the burned-in MAC address, the attacker (e.g., 165 of FIG. 1) may potentially track packets sent by the STA continuously over time.

In embodiments involving UHR communications, the MAC address contained within the PPDU 200 may be an IRM address instead of the burned-in (or hardware) address. In some embodiments, the IRM address may be randomly generated each epoch to enhance privacy. As used herein, an epoch may refer to a time period during which a specific network configuration is valid. At the end of each epoch, new parameters may be generated, such as refreshing the IRM address, security tokens, session keys, or other configuration settings, to maintain the security and privacy of the communications. In some embodiments, the duration of an epoch may be minutes, seconds, or any other interval determined based on the network requirements and privacy concerns. By extracting the IRM address, in some embodiments, the attacker (e.g., 165 of FIG. 1) may only track data packets sent within a limited time frame (e.g., the current epoch). However, the privacy enhancements provided by IRM may be compromised when the PPDU includes a vendor-specific PHY extension.

If the PPDU 200 includes a vendor-specific PHY extension (e.g., the presence of the VS SIG field 205-6), the attacker may examine the extension to find the vendor ID (contained within the vendor ID sub-field 210-1) and relevant proprietary parameters (contained within the VS content sub-field 210-3). The vendor ID and relevant proprietary parameters may provide the attacker information about the device's requirements and potential capabilities. For example, the vendor ID may disclose the vendor (or manufacturer) of the STA, and the proprietary parameters may reveal device-specific capabilities or configurations, which generally remain the same for devices from the same vendor.

In embodiments where the MAC address changes dynamically with each epoch (e.g., when using IRM addresses), the consistency of the vendor ID and proprietary parameters may be used as an indicator for device tracking. For example, during the first epoch, the attacker may observe a PPDU having a MAC address (e.g., “X”) and associated with a specific vendor ID (e.g., “1”) and proprietary parameters. Once the epoch expires and a new epoch begins, the attacker may detect another PPDU with a different MAC address (e.g., “Y”), but with the same vendor ID (e.g., “1”) and similar proprietary parameters. From this correlation, the attacker may infer that both packets originate from the same device, despite the changing MAC addresses. Following this analysis, the attacker may track the STA's movements and/or usage patterns by continuously identifying packets with the same vendor ID and proprietary parameters. To prevent such unauthorized tracking and improve the security of wireless communications, additional measures to protect device's identity are desired. These measures are discussed in more detail below with reference to FIGS. 3-7.

FIG. 3 depicts an example sequence of message exchanges 300 for obfuscating vendor IDs and managing collisions across basic service sets (BSSs), according to some embodiments of the present disclosure. In this figure, the STA 310 is associated with the AP 305 within a BSS (e.g., BSS 1 (160-1) of FIG. 1), and the BSS is part of a larger ESS (e.g., ESS 100 of FIG. 1) managed by the WLC 315. In some embodiments, the STA 310 may correspond to the STAs 110 as depicted in FIG. 1. In some embodiments, the AP 305 may correspond to the APs 105 as depicted in FIG. 1.

As illustrated, STA 310 and AP 305 establish an association link to ensure secure data transmission throughout the first epoch 380 (step 320). The link is initiated using an IRM address that STA 310 generates for the first epoch 380. For example, the IRM address may be included within the authentication request sent by STA 310, allowing AP 305 to verify its identity. After authentication, STA 310 may further include the IRM address within the association request to ensure that connection parameters between the STA 310 and AP 305 are synchronized for secure and efficient communication. Once the association link is established, STA 310 may include the IRM address in any following data packets it sends to AP 305, indicating the source of the transmission and maintaining consistency in device identification throughout the first epoch 380.

Within the same epoch 380, after establishing the association, STA 310 generates an obfuscated vendor ID to conceal the real (or built-in) vendor ID (step 325). In some embodiments, the obfuscation may involve applying predefined algorithms to the real vendor ID and transforming it into an obfuscated version. The predefined algorithms may define a series of manipulations that significantly change the data format, rendering the original vendor ID unrecognizable. After obfuscation, STA 310 may create a direct mapping between the real and obfuscated vendor IDs. This mapping, often maintained in a lookup table, may facilitate a quick reversion to the real vendor ID based on the obfuscated version. In some embodiments, cryptographic techniques may be used, such as using a cryptographically secure pseudo-random number generator (CS-PRNG). In this configuration, the real vendor ID may be combined (e.g., using an Exclusive-OR (XOR) operation) with a pseudo-random number generated by the CS-PRNG. The combination may result in a unique obfuscated vendor ID that can only be reverted if the receiving device, AP 305, uses the same seed or cryptographic key to regenerate the identical pseudo-random number initially used in the obfuscation process.

The figure illustrates the process by which the vendor ID is obfuscated to enhance privacy and security for wireless communications. Such obfuscation is important because the vendor ID may potentially reveal sensitive information about the device's vendor (or manufacturer), which can be exploited by malicious entities (e.g., the attacker 165 of FIG. 1) to track the device's movements or explore vulnerabilities associated with the device's vendor (or manufacturer). By obfuscating the vendor ID, STA 310 may effectively reduce the risk of targeted attack, increasing the overall security of the network environment.

In some embodiments, instead of or in addition to vendor ID, other vendor-specific data may also be obfuscated to further protect the user privacy. The other vendor-specific data may include information contained within the VS SIG field (e.g., 205-6 of FIG. 2) of the data packet, such as firmware version numbers, certain hardware identifiers, specific protocol details, or proprietary configuration settings, among others. These parameters, if exposed, may provide attackers with insights into the device's identity and operational framework.

After the obfuscation process is complete, STA 310 sends the obfuscated vendor ID to AP 305 (step 330), requesting AP 305 to verify the uniqueness of the ID across the current network (or least that all devices using the obfuscated vendor ID share the same original vendor ID). In some embodiments, the obfuscated vendor ID may be transmitted as part of a management frame or a custom vendor-specific action frame.

In some embodiments, the obfuscated vendor ID may serve as a primary identifier in the preamble of a data packet (e.g., PPDU), allowing the receiving device, AP 305, to recognize the source and destination of incoming packets and facilitate appropriate bridging. This is because other identifiers, such as the BSSID and MAC addresses, are embedded within the payload (e.g., in the MAC header 215-1 as depicted by FIG. 2) and are not immediately visible during the initial stages of packet processing. Thus, the obfuscated vendor ID may serve as the primary identifier for quickly classifying and managing the packet before payload analysis is performed. If two STAs, like STA 310 and another STA within the same network, using different vendor IDs, generate the same obfuscated vendor ID, it may lead to misidentification and erroneous data reception. Specifically, AP 305 may mistakenly identify packets from one entity as originating from the other entity, leading to incorrect processing and/or mismanagement of network resources. In simple network configurations where an AP is associated with a limited number of STAs, the likelihood of collisions for obfuscated vendor IDs is relatively low. As the network expands to larger and high-density (HD) deployments, such as an ESS that comprises multiple overlapping BSSs and each co-channel AP associated with a large number of STAs, the risk for ID collisions increases significantly. Each STA within the ESS may utilize vendor-specific configurations. A sufficient condition is a unique obfuscated vendor ID for proper data handling and resource allocation. A necessary condition is that each obfuscated vendor ID in a PPDU intended for an AP is always used for a single underlying vendor ID, albeit this looser condition may impair some network functions.

As illustrated, upon receiving the obfuscated vendor ID from STA 310, AP 305 forwards the ID to the WLC 315 (step 335). In some embodiments, the WLC 315 may correspond to the WLC 125 as depicted in FIG. 1, which oversee the operations of APs within the ESS. In some embodiments, the obfuscated vendor ID may be transmitted as part of a management frame or a custom vendor-specific action frame.

Upon receiving the obfuscated vendor ID, the WLC 315 verifies its uniqueness (or the uniqueness of its mapping from vendor ID to obfuscated vendor ID) across the BSSs (step 340). In some embodiments, the WLC 315 may be connected to a centralized database that tracks active obfuscated vendor IDs (or vendor ID mappings) within the ESS to ensure no duplicates exist. The WLC may check the database to determine whether the current obfuscated vendor ID generated by STA 310 is available for use.

Based on the validation check, the WLC 315 sends the result back to AP 305 (step 345), possibly using an encapsulated management frame or a custom vendor-specific action frame. AP 305 then forwards the unencapsulated result to STA 310 (step 350).

Upon receipt, STA 310 analyzes the validation result to determine the next step. If the result reveals that the current obfuscated vendor ID (or vendor ID to obfuscated vendor ID mapping) is in use by another device within the ESS, STA 310 proceeds to generate a new obfuscated vendor ID and sends it again for validation. If the result confirms that the current obfuscated vendor (or vendor ID to obfuscated vendor ID mapping) is unique and available for use (step 355), suggesting the ID has not been used by other devices within the ESS, STA 310 proceeds to send an encrypted message to AP 305 (step 360). The encrypted message may include relevant data to revert the obfuscated vendor ID back to the real vendor ID. In some embodiments, the encrypted message may include a direct mapping between the obfuscated and real vendor IDs, allowing AP 305 to identify the real vendor ID by looking up this mapping. In some embodiments, the message may contain a cryptographic key that AP 305 may use to generate the same pseudo-random number used in the obfuscation process. Once generated, the pseudo-random number may be XORed with the obfuscated vendor ID to recover the real vendor ID.

Following the transmission of the encrypted message, STA 310 transmits data packets with the obfuscated vendor ID to AP 305 (step 365). In some embodiments, the obfuscated vendor ID may be incorporated into the vendor ID sub-field (e.g., 210-1 of FIG. 2), which is part of the VS SIG field (e.g., 205-6 of FIG. 2) within the UHR preamble. The placement ensures that the obfuscated vendor ID is processed at the earliest stage of data handling by AP 305.

In another embodiment, STA 310 may report the vendor ID (or data necessary to revert the obfuscated vendor ID to the real one) as well as the obfuscated vendor ID at step 330, so that the operations at step 360 are not needed. The network assumes the obfuscation is in use immediately after the validation response at step 350 is sent.

As depicted, AP 305 decrypts the received message to access the contents (step 370). In some embodiments, symmetric encryption/decryption techniques may be used, where a secret key is shared between AP 305 and STA 310. STA 310 may apply the shared secret key to encrypt the message, using an algorithm like advanced encryption standard (AES). Upon reception, AP 305 may use the same secret key to decrypt the message and access the original content. As discussed above, the message may include a cryptographic key, a direct mapping, or other parameters that are specifically configured to recover the real vendor ID from its obfuscated form. In embodiments where a direct mapping is provided, indicating the correspondence between the obfuscated and real vendor IDs, AP 305 may apply the mapping to decode and recover the real vendor ID. In embodiments where a cryptographic key is provided, AP 305 may apply the cryptographic key to generate the same pseudo-random number used in the obfuscation process, and XOR the number with the obfuscated vendor ID to recover the real vendor ID.

As depicted, once the real vendor ID is recovered, AP 305 optimizes its local configurations, such as modifying the receiver's behavior in processing data, based on the vendor-specific PHY parameters associated with the vendor ID (step 375). In some embodiments, the adjustments may include tuning physical layer settings, such as LNA gain levels, tracking algorithms, channel smoothing algorithms, data rates, and error correction schemes, among others. These changes may help to better align AP 305's network configurations with the specific requirements and capabilities of STA 310, to ensure improved performance and compatibility within the network environment.

In some embodiments, STA 310 may continue to track the time and determine whether the current epoch has expired. If the epoch has not yet expired, STA 310 may continue to use the validated obfuscated vendor ID within data packets that include a vendor-specific PHY extension. If the epoch expires and a new epoch begins, the STA 310 may generate a new obfuscated vendor ID (step 325), and the new ID may then be transmitted to AP 305 for validation (steps 330-350), following the same procedures as before. The generation of a new obfuscated vendor ID at the beginning of each epoch may facilitate dynamic network security management, mitigating the potential security risks associated with the long-term use of a static obfuscated vendor ID.

When an attacker (e.g., 165 of FIG. 1) is within the range of AP 305 and intercepts traffic transmitted between STA 310 and AP 305, there is a risk that certain intercepted messages may inadvertently reveal sensitive information about the sending device's identity or operational status. This may include the message sent by STA 310 to AP 305 reporting the obfuscated vendor ID (step 330) (which may reveal the obfuscated vendor ID), transmitted data packets from STA 310 to AP 305 (step 360) (which may reveal the MAC address of STA 310, the BSSID, and the obfuscated vendor ID), and encrypted messages from STA 310 to AP 305 (step 365) (which may reveal the relevant data for reverting the obfuscation).

However, since the vendor ID is obfuscated and the relevant data to revert the obfuscation is encrypted and sent in a separate message, the attacker, despite intercepting the traffic, may remain unable to recover the real vendor ID. Additionally, due to the dynamic nature of the obfuscated vendor ID, which is renewed each epoch, the obfuscated vendor ID or other vendor-specific PHY information may no longer serve as reliable indicators for identifying the STA 310 and/or tracking its activities over time across different epochs. This frequency renewal of the IRM address and/or vendor ID in UHR communications may significantly complicate any potential tracking efforts, as each epoch effectively resets the identifiable information to ensure that past data cannot be linked to future activities within the network. For example, the attacker (e.g., 165 of FIG. 1) may observe that a data packet intercepted in the first epoch 380 has an IRM address “X” and an obfuscated vendor ID “11223,” while a data packet intercepted in a second epoch has an IRM address “Y” and an obfuscated vendor ID “15543.” Without the ability to revert the obfuscation and recover the real vendor ID, the attacker is unable to correlate these observations to conclude that these packets originate from the same device. As a result, the obfuscation of vendor ID may effectively prevent unauthorized tracking over time, preserving user privacy and enhancing overall network security.

The illustrated sequence of interactions 300, which involves validating the uniqueness of an obfuscated vendor ID via the WLC 315 by checking a centralized database, is provided for conceptual clarity. In some embodiments, instead of or in addition to relying solely on database checks, the WLC 315 may assign a specific range of values to each BSS within the ESS. The obfuscated vendor ID generated by an STA within a specific BSS should fall within its assigned range. For example, if STA 310 and AP 305 form BSS 1 (e.g., 160-1 of FIG. 1), the WLC 315 may assign a specific value range to BSS 1. All obfuscated vendor IDs generated by STA 310 may then fall within the assigned range for BSS 1. Such allocation may effectively prevent ID conflicts between different BSSs within the same ESS. In embodiments where the BSS 1 (e.g., 160-1 of FIG. 1) includes a tunneled direct link setup (TDLS) pair, which allows direct communications between devices in the same BSS bypassing the AP 305, the AP 305 may further subdivide its assigned range, and allocate a specific sub-range to the TDLS pair. The subdivision may prevent ID overlaps within the same BSS, particularly when direct links are established.

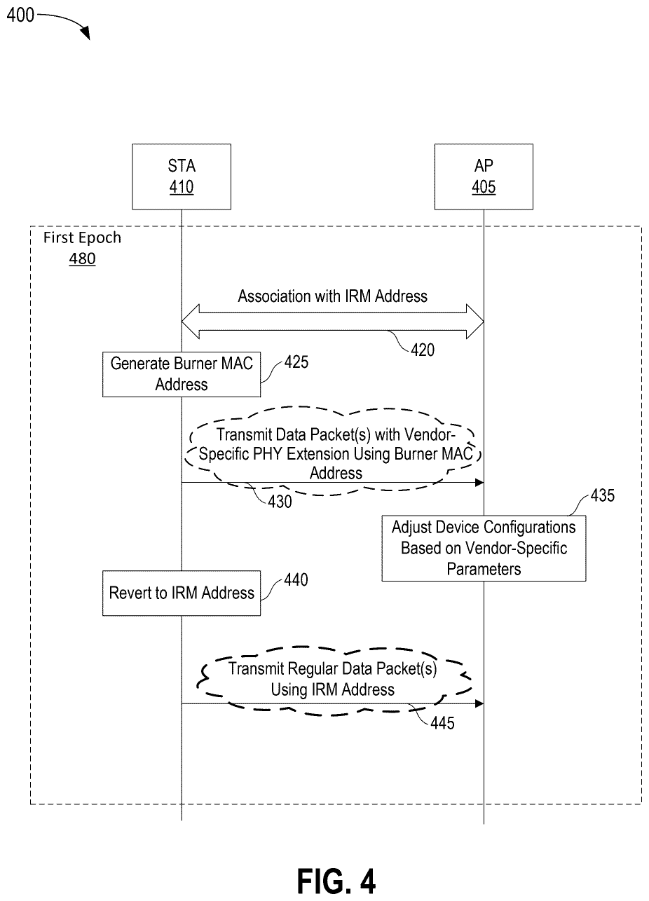

FIG. 4 depicts an example sequence of message exchanges 400 for generating and utilizing a burner MAC address in vendor-specific PHY communications, according to some embodiments of the present disclosure.

As illustrated, STA 410 and AP 405 establish an association link using an IRM address that STA 410 generates for the first epoch 480 (step 420). In some embodiments, the STA 410 may correspond to the STAs 110 as depicted in FIG. 1. In some embodiments, the AP 405 may correspond to the APs 105 as depicted in FIG. 1.

After the connection is established between STA 410 and AP 405, STA 410 proceeds to assess its operational requirements based on current network conditions and its specific needs. Based on the assessment, STA 410 may determine whether vendor-specific PHY extensions should be included within the data packets. These extensions may contain data that informs AP 405 about STA 410's vendor-specific requirements and capabilities. Based on the information, AP 405 may adjust its operation and service parameters to further optimize the connection. If STA 410 determines that vendor-specific PHY extensions are to be included within the data packets, STA 410 generates a temporary burner (e.g., disposable) MAC address (step 425). As used herein, the burner MAC address may refer to an address used exclusively for communications that involve vendor-specific PHY extensions. The burner MAC address is generated to protect the device's identity during these specialized activities.

STA 410 incorporates the burner MAC address into the MAC header of the data packets that contain the vendor-specific PHY extensions and transmit the packets to AP 305 (step 430). This step ensures that transmissions related to vendor-specific data are separated from regular data traffic.

Upon receiving the data packets with the burner MAC address and vendor-specific PHY extensions, AP 305 examines the extensions (e.g., the VS SIG field 205-6 within the UHR preamble, as depicted in FIG. 2) to extract the vendor ID (e.g., contained within the vendor ID sub-field 210-1, as depicted in FIG. 2) and relevant vendor-specific parameters (e.g., contained within the VS content sub-field 210-3, as depicted in FIG. 2). AP 405 then adjust its device configurations based on the vendor-specific data (step 435), including, but not limited to, tuning LNA gain settings, adjusting tracking algorithms and/or channel smoothing algorithms, and modifying data rates and error correction protocols. Such changes may be implemented to better accommodate the specific capabilities and requirements of STA 410 as conveyed through the vendor-specific PHY extensions.

After the communication involving vendor-specific PHY extensions is complete, STA 410 reverts to its IRM address (step 440), which is the address originally used to establish the association link during the first epoch 480. STA 410 then incorporates the IRM address into the regular data packets that do not include vendor-specific PHY extensions and transmits the data packets to AP 405 (step 445).

In some embodiments, STA 410 may continue to track the time and determine whether the current epoch 480 has expired. If the epoch has not expired, STA 410 may continue to use the burner MAC address for communications that involve extensions, and maintains the current IRM address for regular communications. If the epoch expires and a new epoch begins, the STA 410 may generate a new IRM address and a new burner MAC address for subsequent communications. In some embodiments, STA 410 may generate a new burner MAC address within the same epoch each time it determines that vendor-specific data should be transmitted. For example, after completing a sequence of regular data transmissions (step 445) and before the first epoch 480 expires, STA 410 may anticipate the need for additional communications involving vendor-specific PHY extensions. In response, STA 410 may generate a new burner MAC address, different from any previously used within the same epoch, and use the new address for the subsequent transmission of vendor-specific data.

The operation of using different MAC addresses for regular and extension-involved communications, coupled with the renewal of these addresses each epoch, enhances user privacy and prevents unauthorized device identification and tracking. When an attacker is within the signal range of AP 405 and intercepts traffic between AP 405 and STA 410, the attacker (e.g., 165 of FIG. 1) may be exposed to a series of MAC address changes that protect the identity of STA 410. For example, the attacker may observe that, during the first epoch 480, regular data packets (sent at step 445) use a first MAC address (e.g., “X1”) (which is the IRM address used to establish the association link during the first epoch), while packets involving vendor-specific PHY extensions (sent at step 430) use a second MAC address (e.g., “Y1”) (which is the burner MAC address generated for extension-involved communications). In the second epoch, the regular data packets may switch to a third MAC address (e.g., “X2”), and the extension-involved packets may switch to a fourth MAC address (e.g., “Y2”). Even if the attacker notices that similar vendor-specific data, such as identical vendor IDs or proprietary parameters, are consistently present across extension-involved packets from both epochs, the attacker may, at most, speculate that the two burner MAC addresses (e.g., “Y1” and “Y2”) could be linked to the same device. However, since these burner MAC addresses are not used for regular communications and are renewed with each epoch, the attacker is unable to link these burner MAC addresses to the STA's regular IRM addresses (e.g., “X1” and “X2”). Therefore, the attacker cannot track the regular data packets sent by the device over time and across multiple epochs. By continuously refreshing both the IRM and burner MAC addresses with each epoch, STA 410 effectively masks its long-term network usage and movements.

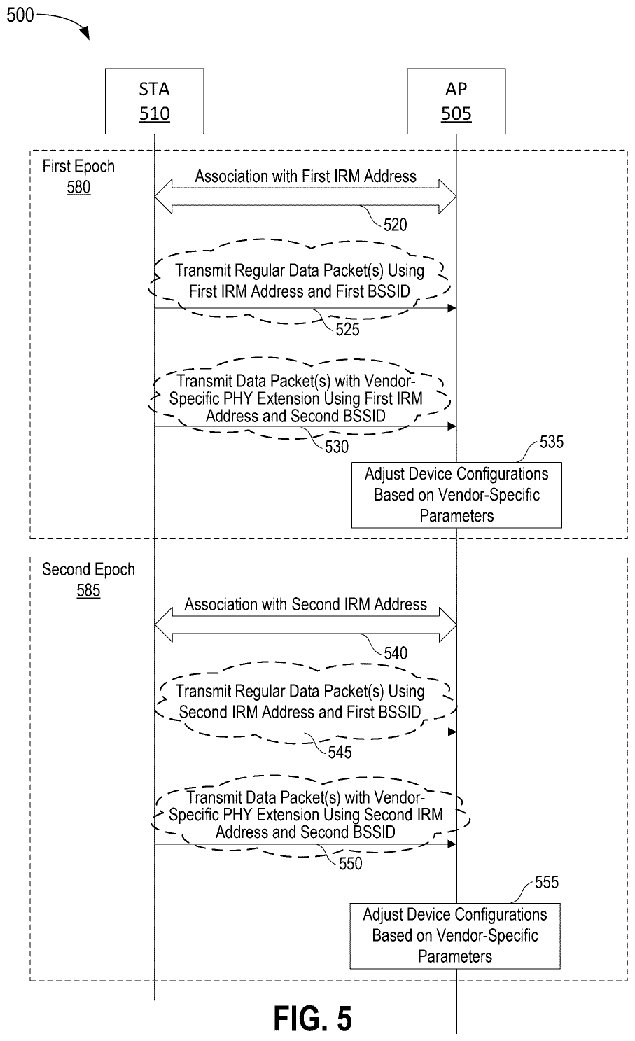

FIG. 5 depicts an example sequence of message exchanges 500 for using dual BSSIDs in vendor-specific PHY communications, according to some embodiments of the present disclosure.

As illustrated, STA 510 establishes an association link with AP 405 using a first IRM address (step 520). As used herein, the first IRM address may refer to the address that STA 510 randomly generates for the first epoch 580 to conceal STA 510's burned-in (or hardware) MAC address. The IRM address may protect the device's identity from being tracked across different epochs. In some embodiments, the STA 510 may correspond to the STAs 110 as depicted in FIG. 1. In some embodiments, the AP 505 may correspond to the APs 105 as depicted in FIG. 1.

In conventional Wi-Fi networks, the BSSID is typically the MAC address of the AP and is used to identify each BSS within the ESS. In this figure, the AP 505 may be configured with two different BSSIDs to separate regular communications from vendor-specific communications. In some embodiments, the first BSSID may be the physical MAC address of the AP 505 and be used for regular data transmissions that do not involve vendor-specific PHY extensions. In some embodiments, the second BSSID may be generated for handling communications that involve vendor-specific PHY extensions. In some embodiments, the second BSSID may be randomly generated as long as it is different from the first BSSID. In some embodiments, a cryptographic hash function may be applied to the AP's physical MAC address to generate a unique but related BSSID. The generated BSSID may then be used within extension-involved communications.

In some embodiments, the two BSSIDs may be communicated by AP 505 to STA 510 during the association process, such as via the association response. The message may inform STA 510 of the two different BSSIDs available for regular and vendor-specific communications.

After the completion of the association, STA 510 sends data packets that do not include the vendor-specific PHY extensions to AP 505 (step 525). The data packets contain the first BSSID (e.g., “X1”), which is specifically designed for handling regular commutations, and the first IRM address of STA 510 (e.g., “Y1”).

When data packets that include vendor-specific PHY extensions need to be transmitted, STA 510 prepares these packets to include the second BSSID (e.g., “X2”), which is reserved for extension-involved commutation, and the first IRM address of STA 510 (e.g., “Y1”). STA 510 then sends these packets to AP 505 (step 530).

Upon receipt, AP 505 analyzes the received data packets to extract vendor-specific data, such as the vendor ID and other proprietary parameters. Based on the data, AP 505 adjusts its device configurations accordingly to optimize handling and support for these vendor-specific requirements (step 535). In some embodiments, STA 510 may continue to monitor the time and determine if the first epoch 580 has expired. If not, STA 510 may continue to use the first IRM address (e.g., “Y1”) for regular and extension-involved communications.

Upon the expiration of the first epoch 580 and the beginning of the second epoch 585, STA 510 generates a second IRM address (e.g., “Y2”) and uses it to reestablish the association link with AP 505 for continued communications (step 540). With the second IRM address (e.g., “Y2”), STA 510 sends regular data packets using the first BSSID (e.g., “X1”) to AP 505 (step 545), and extension-involved packets (e.g., packets with vendor-specific PHY extensions) using the second BSSID (e.g., “X2”) (step 550). AP 505 receives these new epoch data packets and performs a similar analysis as in step 535, such as extracting updated vendor-specific data and adjusting relevant configurations to continue supporting these requirements (step 555).

In some embodiments, utilizing different BSSIDs (e.g., “X1” and “X2”) for regular and extension-involved communications may enhance network security and privacy, particularly in preventing unauthorized tracking based on observing similar vendor-specific data. For example, an attacker (e.g., 165 of FIG. 1) monitoring traffic between STA 510 and AP 505 may notice that extension-involved packets transmitted during the first epoch 580 (e.g., packets transmitted at step 530) contain the first IRM address (e.g., “Y1”) and the second BSSID designed for vendor-specific communications (e.g., “X2”). In the second epoch 585, the attacker may observe that extension-involved packets have a different IRM address (e.g., “Y2”) but the same BSSID (e.g., “X2”) (e.g., packets transmitted at step 550). While these packets may contain similar vendor-specific data, such as identical vendor IDs or proprietary parameters, the presence of different IRM addresses (e.g., “Y1” and “Y2”) may complicate the attacker's ability to link these packets to the same device. Additionally, the use of dual BSSIDs effectively separates regular traffic from extension-involved communications. Therefore, even if the attacker intercepts regular data packets transmitted between STA 510 and AP 505 across different epochs (e.g., packets transmitted at steps 525 and 545), the attacker may lack the ability to link these packets to a specific device identity.

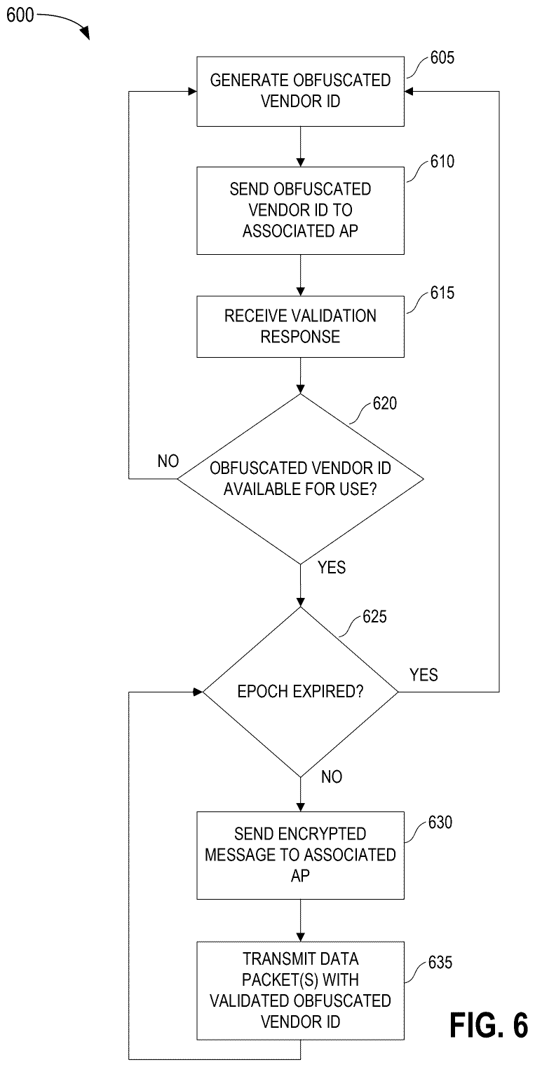

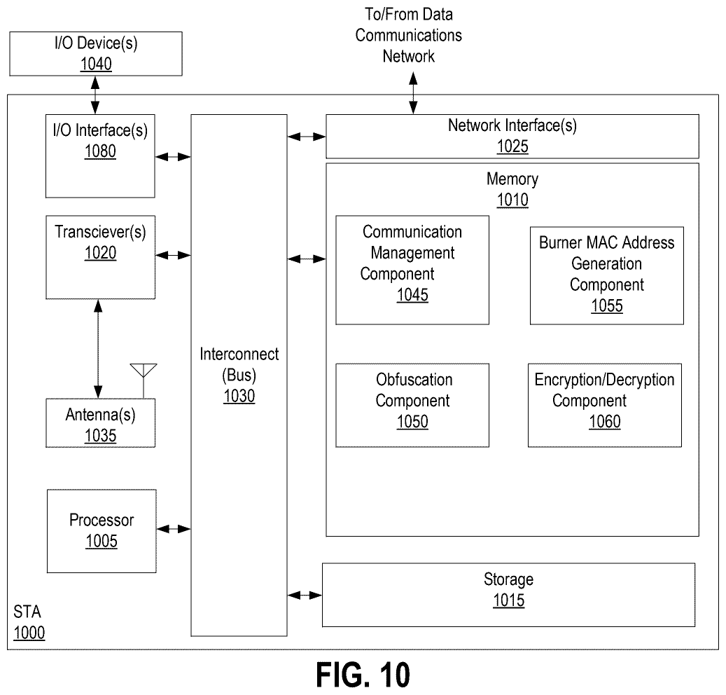

FIG. 6 depicts an example method 600 for a STA to obfuscate and validate vendor IDs within an ESS, according to some embodiments of the present disclosure. In some embodiments, the method 600 may be performed by the STAs 110 as depicted in FIG. 1, the STA 310 as depicted in FIG. 3, the STA 410 as depicted in FIG. 4, the STA 510 as depicted in FIG. 5, and the client device 1000 as depicted in FIG. 10.

The method 600 begins at block 605, where a STA (e.g., 110-1 of FIG. 1) generates an obfuscated vendor ID to mask its real (or built-in) vendor ID. The generation process may involve applying predefined transformation algorithms or cryptographic techniques (e.g., CS-PRNG) to convert the real vendor ID into an obfuscated version.

At block 610, the STA (e.g., 110-1 of FIG. 1) transmits the obfuscated vendor ID to its associated AP (e.g., AP 105-1 of FIG. 1). The STA and the AP are components of a BSS (e.g., BSS 1 (160-1) of FIG. 1), which is part of a larger ESS (e.g., ESS 100 of FIG. 1). The message requests the AP to validate the uniqueness and availability of the newly generated obfuscated vendor ID within the current network. Upon receiving the obfuscated vendor ID, in some embodiments, the AP may forward the ID to the WLC (e.g., 125 of FIG. 1) that manages the ESS. The WLC may then check a centralized database that tracks obfuscated vendor IDs currently in use within the ESS. By checking the database, the WLC may determine whether the submitted ID is unique and not currently assigned to any other device in the network.

At block 615, the STA receives a response from the associated AP regarding the status of the obfuscated vendor ID, indicating whether it is available for use or not.

At block 620, the STA analyzes the response to determine further actions. If the repose confirms that the obfuscated vendor ID (or vendor ID to obfuscated vendor ID mapping) is unique and available, suggesting no other device within the ESS is using this ID, the method 600 proceeds to block 625. If the response reveals that the obfuscated vendor ID (or mapping) is not unique, indicating that the ID (or mapping) conflicts with an existing ID within the ESS, the method 600 returns to block 605, where the STA regenerates a new obfuscated vendor ID.

At block 625, the STA monitors the current epoch to determine if it has expired. If the epoch has not expired, the method 600 proceeds to block 630, where the STA encrypts the relevant data to revert the obfuscation in a separate message, and sends this message to the associated AP. In some embodiments, the data to revert the obfuscation may include a direct mapping between the obfuscated and real vendor IDs or a cryptographic key that the AP may use to convert the obfuscated vendor ID back to the real one. After sending the encrypted message, the method 600 returns to block 625, where the STA continues to monitor the current epoch, to ensure the obfuscated vendor ID is updated when the defined time frame expires. In some embodiments, the real vendor ID (or data to revert the obfuscated ID to the real one) may be sent along with the obfuscated ID by the STA to the AP (as depicted at block 610). In such a configuration, the AP may assume that the obfuscation is in use immediately after sending the positive validation response.

At block 635, the STA uses the validated obfuscated vendor ID in network operations. For communications involving vendor-specific PHY extensions, the STA may include the obfuscated vendor ID into uplink data packets and transmit them to the associated AP. If the epoch has expired, the method 600 returns to block 605, where the STA regenerates a new obfuscated vendor ID. The regeneration allows for a dynamic refresh of the vendor ID at each epoch.

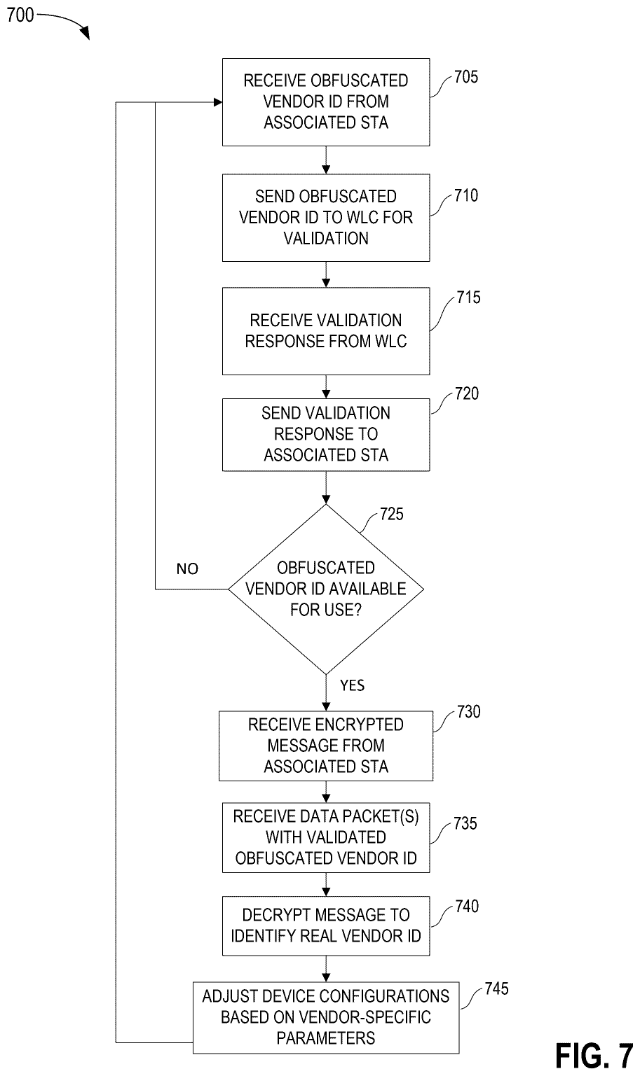

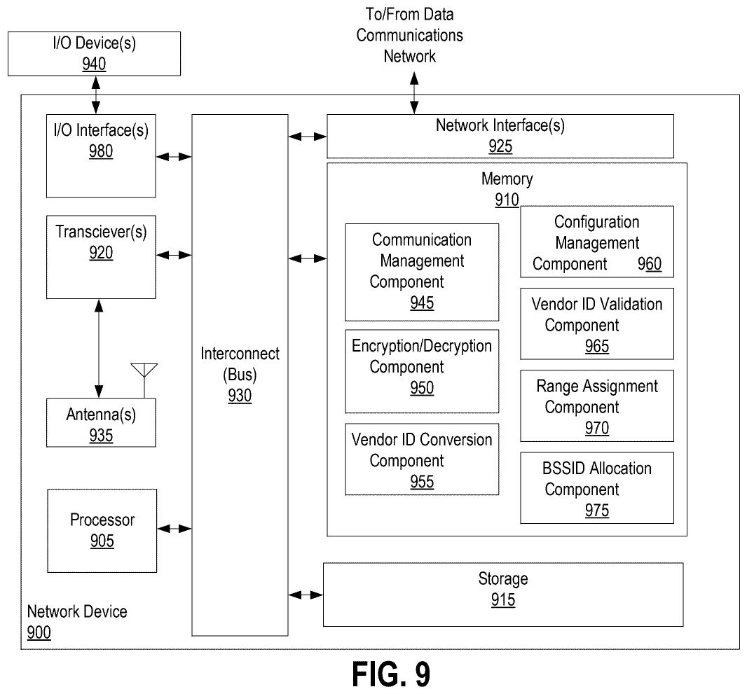

FIG. 7 depicts an example method 700 for an AP to coordinate obfuscated vendor IDs within an ESS, according to some embodiments of the present disclosure. In some embodiments, the method 700 may be performed by one or more APs, such as the APs 105 as depicted in FIG. 1, the AP 305 as depicted in FIG. 3, the AP 405 as depicted in FIG. 5, and the AP 505 as depicted in FIG. 5. In some embodiments, the method 700 may be performed by one or more other network devices that possess the required capabilities for dynamic network management, such as the WLC 125, router 120, and network switch 115 as depicted in FIG. 1, the WLC 315 as depicted in FIG. 3, and the network device 900 as depicted in FIG. 9.

At block 705, an AP (e.g., 105-1 of FIG. 1) receives an obfuscated vendor ID from one of its associated STAs (e.g., STA 110-1 of FIG. 1). The obfuscated vendor ID is generate by the STA to conceal the real vendor ID, to protect user privacy and prevent unauthorized tracking. In some embodiments, the obfuscated vendor ID may be sent as part of a management frame or a custom vendor-specific action frame.

At block 710, the AP forwards the received obfuscated vendor ID to a WLC. In some embodiments, the AP and the associated STA may be components of a BSS (e.g., BSS 1 (160-1) of FIG. 1), which is part of a larger ESS (e.g., 100 of FIG. 1) managed by the WLC (e.g., 125 of FIG. 1). The WLC may check the ID against a database of currently active obfuscated vendor IDs within the ESS to ensure there is no overlap and the ID is unique.

At block 715, the AP receives a validation response from the WLC regarding the status of the obfuscated vendor ID (either confirmed as unique and available, or rejected due to a conflict).

At block 720, the AP forwards the response back to the STA, informing it of the validation results.

At block 725, the AP analyzes the validation result to determine further actions. If the response reveals that the obfuscated vendor ID (or vendor ID to obfuscated vendor ID mapping) is unique and available for use, the associated STA may proceed to prepare encrypted messages and transmits data packets to the AP. In this configuration, the method 700 moves to block 730, where the AP (e.g., 105-1 of FIG. 1) receives an encrypted message from the STA. In some embodiments, the message may contain the relevant information to revert the obfuscated vendor ID back to the real vendor ID. In some embodiments, the message may be encrypted using a secret key shared between the STA and the AP. In some embodiments, the data used to revert the obfuscation may include a direct mapping between the obfuscated and real vendor IDs. In some embodiments, the message may include a cryptographic key used in CS-PRNG setup. Using this key, the AP may generate the pseudo-random sequence initially used for obfuscation and, through operations like XOR, revert the obfuscated vendor ID back to its original form.

If there is a conflict, suggesting that the obfuscated vendor ID is already in use, the AP may direct the STA to generate a new obfuscated vendor ID and/or specify the current obfuscated ID (or mapping) aligns with that used by another STA. In this configuration, the method 700 returns to block 705, where the AP receives a new obfuscated vendor ID from the associated STA, and then forwards the ID to the WLC for validation.

At block 735, the AP receives data packets from the STA that include the obfuscated vendor ID. In some embodiments, the obfuscated vendor ID may be embedded within the VS SIG field (e.g., 205-6 of FIG. 2), which is part of the UHR preamble within the PPDU. The AP may process the PPDU to read this data. The early reading of the obfuscated vendor ID from the preamble allows the AP to identify the data source promptly, and apply specific configurations or optimizations early in the packet reception process.

At block 740, the AP decrypts the received message using the shared secret key with the STA, and then applies the provided mapping or cryptographic key to revert the obfuscated vendor ID back to the real vendor ID.

At block 745, utilizing the identified real vendor ID and other relevant vendor-specific parameters, the AP adjusts the device configurations to optimize performance and compatibility specific to the STA's requirements. In some embodiments, the adjustments may involve tuning physical layer settings, including, but not limited to, LNA gain settings, tracking algorithms, channel smoothing algorithms, modulation schemes, channel selections, and error correction protocols.

The example methods 600 and 700 in FIGS. 6 and 7 depict the obfuscation of vendor IDs to protect the device's identity and prevent unauthorized tracking. The example methods 600 and 700 are provided for conceptual clarity. In some embodiments, other vendor-specific data (e.g., contained within the VS SIG field), such as firmware version numbers, hardware identifiers, or other sensitive parameters, may also be obfuscated to enhance privacy and security further.

The example methods 600 and 700 in FIGS. 6 and 7 depict validating the availability of an obfuscated vendor ID through a WLC. The example methods are provided for conceptual clarity. In some embodiments, to further enhance the management and security of vendor IDs within a large network (e.g., ESS), the WLC may assign a specific range of values to each BSS. Any obfuscated vendor ID generated by a STA within a BSS should fall within the predetermined range assigned to the specific BSS. This allocation strategy not only reduces the risk of conflicts but also simplifies ID management, as validation of each ID's uniqueness no longer needs to pass through the WLC for each transaction.

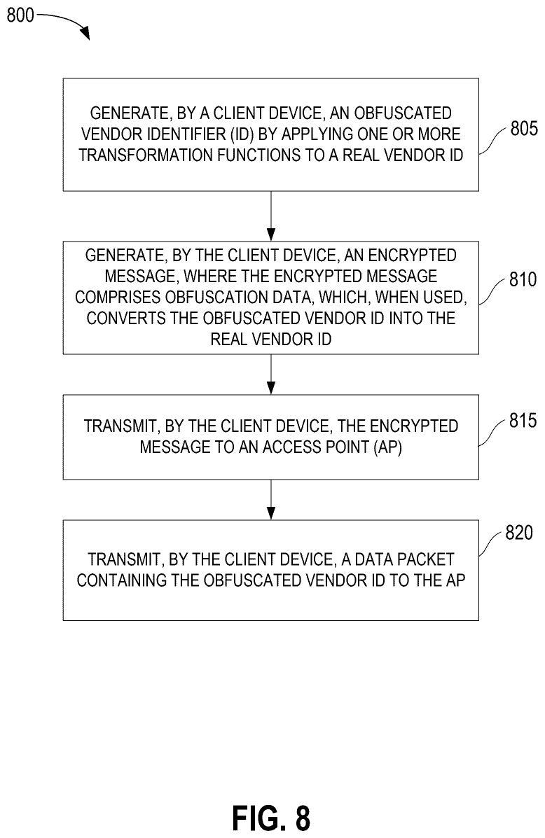

FIG. 8 is a flow diagram depicting an example method 800 for vendor ID obfuscation and coordination to avoid unauthorized tracking, according to some embodiments of the present disclosure.

At block 805, a client device (e.g., 310 of FIG. 3) generates an obfuscated vendor identifier (ID) by applying one or more transformation functions to a real vendor ID. In some embodiments, the obfuscated vendor ID may be generated for a first epoch, and a second obfuscated vendor ID may be generated for a second epoch.

At block 810, the client device generates an encrypted message, where the encrypted message comprises obfuscation data, which, when used, converts the obfuscated vendor ID into the real vendor ID. In some embodiments, the obfuscation data may comprise at least one of a cryptographic key or a mapping between the obfuscated vendor ID and the real vendor ID.

At block 815, the client device transmits the encrypted message to an access point (AP) (e.g., 305 of FIG. 3).

At block 820, the client device transmits a data packet containing the obfuscated vendor ID to the AP.

In some embodiments, the AP and the client device may belong to a first basic service set (BSS) (e.g., BSS 1 (160-1) of FIG. 1) that is part of an extended service set (ESS) (e.g., ESS 100 of FIG. 1).

In some embodiments, the AP (e.g., 105-1 of FIG. 1) may coordinates with other APs (e.g., 105-2 of FIG. 1) within the ESS to determine if the obfuscated vendor ID has been used by other client devices within the ESS.

In some embodiments, the client device may further transmit the obfuscated vendor ID to the AP, receive a confirmation from the AP, indicating that the obfuscated vendor ID has not been used, and, subsequent to receiving the confirmation, transmit the data packet containing the obfuscated vendor ID to the AP.

In some embodiments, the obfuscated vendor ID may fall within a range of values allocated to the first BSS within the ESS.

In some embodiments, the client device may further generate a temporary address, embedding the temporary address in the data packet containing the obfuscated vendor ID, transmitting the data packet to an access point (AP), and, subsequent to the transmission, disposing of the temporary address.

In some embodiments, the obfuscated vendor ID may be embedded within a vendor-specific physical layer (PHY) extension of the data packet.

In some embodiments, the AP may be assigned a first basic service set identifier (BSSID) and a second BSSID. In some embodiments, the client device may further embed the first BSSID and a dynamic address in the data packet when the vendor-specific physical layer (PHY) extension is not used, and embed the second BSSID and the dynamic address in the data packet when the vendor-specific physical layer (PHY) extension is used.

FIG. 9 depicts an example network device 900 configured to perform various aspects of the present disclosure, according to some aspects of the present disclosure. In some embodiments, the example network device 900 may correspond to APs 105 as depicted in FIG. 1, AP 305 as depicted in FIG. 2, AP 405 as depicted in FIG. 4, and AP 505 as depicted in FIG. 5. In some embodiments, the example network device 900 may correspond to WLC 125, as depicted in FIG. 1, and WLC 315 as depicted in FIG. 3.

As illustrated, the example network device 900 includes a processor 905, memory 910, storage 915, one or more transceivers 920, one or more I/O interfaces 980, and one or more network interfaces 925. In some embodiments, I/O devices 940 are connected via the I/O interface(s) 980. Further, via the network interface 925, the network device 900 can be communicatively coupled with one or more other devices and components (e.g., via a network, which may include the Internet, local network(s), and the like). Each of the components is communicatively coupled by one or more buses 930. In some embodiments, one or more antennas 935 may be coupled to the transceivers 920 for transmitting and receiving wireless signals.

The processor 905 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 905 processes information received through the transceiver 920, I/O interfaces 980, and the network interfaces 925. The processor 905 retrieves and executes programming instructions stored in memory 910, as well as stores and retrieves application data residing in storage 915.

The storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 915 may store a variety of data for the efficient functioning of the system.

The memory 910 may include random access memory (RAM) and read-only memory (ROM). The memory 910 may store processor-executable software code containing instructions that, when executed by the processor 905, enable the network device 900 to perform various functions described herein for wireless communication. In the illustrated example, the memory 910 includes four software components: the communication management component 945, the encryption/decryption component 650, the vendor ID conversion component 955, and the configuration management component 960. In some embodiments, the communication management component 945 may be configured to manage communications with associated STAs and the WLC, such as receiving and forwarding obfuscated vendor IDs for validation, processing data packets that include vendor-specific PHY extensions, and receiving encrypted messages. In some embodiments, the encryption/decryption component 950 may handle the encryption and decryption of messages that contain sensitive information, including the relevant data to revert the obfuscation process. In some embodiments, the vendor ID conversion component 955 may be configured to convert obfuscated vendor IDs back to their original forms using either direct mapping or cryptographic methods (e.g., CS-PRNG). In some embodiments, the configuration management component 960 may be designed to adjust the network settings and configurations based on the restored vendor-specific information from the encrypted message. The configuration management component 960 may optimize network performance and compatibility in response to device-specific requirements.

In embodiments where the network device 900 corresponds to a WLC (e.g., 125 of FIG. 1), the memory 910 may include three additional software components: the vendor ID validation component 965, the range assignment component 970, and the BSSID allocation component 975. In some embodiments, the vendor ID validation component 965 may manage the validation of obfuscated vendor IDs against a centralized database to ensure their uniqueness within the ESS. In some embodiments, the range assignment component 970 may assign specific ranges of values to each BSS within the ESS. By doing so, the obfuscated vendor IDs generated by any STA within a BSS should fall within a unique range that does not overlap with those of other BSSs. Therefore, the range assignment component 970 may maintain the uniqueness and integrity of obfuscated vendor IDs across the network, preventing conflicts and simplifying network management. In some embodiments, the BSSID allocation component 975 may be configured to allocate two distinct BSSIDs to each AP within the ESS, one for regular communications and another for vendor-specific communications. The dual BSSID system may enhance user privacy and prevent unauthorized device tracking.

Although depicted as a discrete component for conceptual clarity, in some embodiments, the operations of the depicted components (and others not illustrated) may be combined or distributed across any number of components. Further, although depicted as software residing in memory 910, in some aspects, the operations of the depicted components (and others not illustrated) may be implemented using hardware, software, or a combination of hardware and software.

FIG. 10 depicts an example client device 1000 configured to perform various aspects of the present disclosure, according to some embodiments of the present disclosure. In some embodiments, the example client device 1000 may correspond to STAs 110 as depicted in FIG. 1, STA 310 as depicted in FIG. 3, STA 410 as depicted in FIG. 4, or STA 510 as depicted in FIG. 5.

As illustrated, the example client device 1000 includes a processor 1005, memory 1010, storage 1015, one or more transceivers 1020, one or more I/O interfaces 1080, and one or more network interfaces 1025. In some embodiments, I/O devices 1040 are connected via the I/O interface(s) 1080. Further, via the network interface 1025, the client device 1000 can be communicatively coupled with one or more other devices and components (e.g., via a network, which may include the Internet, local network(s), and the like). Each of the components is communicatively coupled by one or more buses 1030. In some embodiments, one or more antennas 1035 may be coupled to the transceivers 1020 for transmitting and receiving wireless signals.

The processor 1005 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1005 processes information received through the transceiver 1020, I/O interfaces 1070, and the network interfaces 1025. The processor 1005 retrieves and executes programming instructions stored in memory 1010, as well as stores and retrieves application data residing in storage 1015.

The storage 1015 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1015 may store a variety of data for the efficient functioning of the system.

The memory 1010 may include random access memory (RAM) and read-only memory (ROM). The memory 1010 may store processor-executable software code containing instructions that, when executed by the processor 1005, enable the client device 1000 to perform various functions described herein for wireless communication. In the illustrated example, the memory 1010 includes four software components: the communication management component 1045, the obfuscation component 1050, the burner MAC address generation component 1055, and the encryption/decryption component 1060. In some embodiments, the communication management component 1045 may be configured to manage communications with associated APs, such as sending obfuscated vendor IDs for validation, receiving validation responses, incorporating obfuscated vendor IDs into data packets and sending these to associated APs, and transmitting encrypted messages. In some embodiments, the obfuscation component 1050 may manage the generation of obfuscated vendor IDs and possibly other vendor-specific data to protect the device's identity and privacy. The obfuscation component 1050 may use predefined algorithms or cryptographic methods to transform real vendor IDs into obfuscated forms that are used within the network to prevent tracking and unauthorized access. In some embodiments, the burner MAC address generation component 1055 may generate temporary burner MAC addresses for communications that involve vendor-specific PHY extensions. This component 1055 may help to protect the device's MAC address from being exposed or linked to vendor-specific communications. In some embodiments, the encryption/decryption component 1060 may be configured to manage the encryption and decryption of messages that contain the relevant information to revert the obfuscation process, such as a direct mapping or a cryptographic key used in CS-PRNG.

Although depicted as a discrete component for conceptual clarity, in some embodiments, the operations of the depicted components (and others not illustrated) may be combined or distributed across any number of components. Further, although depicted as software residing in memory 1010, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
generating, by a client device, an obfuscated vendor identifier (ID) by applying one or more transformation functions to a real vendor ID;
generating, by the client device, an encrypted message, wherein the encrypted message comprises obfuscation data, which, when used, converts the obfuscated vendor ID into the real vendor ID;
transmitting, by the client device, the encrypted message to an access point (AP); and
transmitting, by the client device, a data packet containing the obfuscated vendor ID to the AP.

2. The method of claim 1, wherein the obfuscated vendor ID was generated for a first epoch, the method further comprising generating a second obfuscated vendor ID for a second epoch.

3. The method of claim 1, wherein the AP and the client device belong to a first basic service set (BSS) that is part of an extended service set (ESS).

4. The method of claim 3, wherein the AP coordinates with other APs within the ESS to determine if the obfuscated vendor ID has been used by other client devices within the ESS.

5. The method of claim 4, further comprising:
transmitting, by the client device, the obfuscated vendor ID to the AP;
receiving, by the client device, a confirmation from the AP, indicating that the obfuscated vendor ID has not been used; and
subsequent to receiving the confirmation, transmitting, by the client device, the data packet containing the obfuscated vendor ID to the AP.

6. The method of claim 3, wherein the obfuscated vendor ID falls within a range of values allocated to the first BSS within the ESS.

7. The method of claim 1, further comprising:
generating, by the client device, a temporary address;
embedding, by the client device, the temporary address in the data packet containing the obfuscated vendor ID;
transmitting, by the client device, the data packet to an access point (AP); and
subsequent to the transmission, disposing, by the client device, of the temporary address.

8. The method of claim 1, wherein the obfuscated vendor ID is embedded within a vendor-specific physical layer (PHY) extension of the data packet.

9. The method of claim 8, wherein the AP is assigned a first basic service set identifier (BSSID) and a second BSSID, the method further comprising:
embedding, by the client device, the first BSSID and a dynamic address in the data packet when the vendor-specific physical layer (PHY) extension is not used; and
embedding, by the client device, the second BSSID and the dynamic address in the data packet when the vendor-specific physical layer (PHY) extension is used.

10. The method of claim 1, wherein the obfuscation data comprises at least one of a cryptographic key or a mapping between the obfuscated vendor ID and the real vendor ID.

11. A system of a client device, comprising:
one or more computer processors; and
one or more memories collectively containing one or more programs, which, when executed by the one or more computer processors, perform operations, the operations comprising:
generating an obfuscated vendor identifier (ID) by applying one or more transformation functions to a real vendor ID;
generating an encrypted message, wherein the encrypted message comprises obfuscation data, which, when used, converts the obfuscated vendor ID into the real vendor ID;
transmitting the encrypted message to an access point (AP); and
transmitting, by the client device, a data packet containing the obfuscated vendor ID to the AP.

12. The system of claim 11, wherein the obfuscation data comprises at least one of a cryptographic key or a mapping between the obfuscated vendor ID and the real vendor ID.

13. The system of claim 11, wherein the AP and the client device belong to a first basic service set (BSS) that is part of an extended service set (ESS).

14. The system of claim 13, wherein the AP coordinates with other APs within the ESS to determine if the obfuscated vendor ID has been used by other client devices within the ESS.

15. The system of claim 14, wherein the one or more programs, which, when executed by the one or more computer processors, perform the operations further comprising:
transmitting the obfuscated vendor ID to the AP;
receiving a confirmation from the AP, indicating that the obfuscated vendor ID has not been used; and
subsequent to receiving the confirmation, transmitting, the data packet containing the obfuscated vendor ID to the AP.

16. The system of claim 13, wherein the obfuscated vendor ID falls within a range of values allocated to the first BSS within the ESS.

17. The system of claim 11, wherein the one or more programs, which, when executed by the one or more computer processors, perform the operations further comprising:
generating a temporary address;
embedding the temporary address in the data packet containing the obfuscated vendor ID;
transmitting the data packet to an access point (AP); and
subsequent to the transmission, disposing of the temporary address.

18. The system of claim 11, wherein the obfuscated vendor ID is embedded within a vendor-specific physical layer (PHY) extension of the data packet.

19. The system of claim 18, wherein the AP is assigned a first basic service set identifier (BSSID) and a second BSSID, and wherein the one or more programs, which, when executed by the one or more computer processors, perform the operations further comprising:
embedding, by the client device, the first BSSID and a dynamic address in the data packet when the vendor-specific physical layer (PHY) extension is not used; and
embedding, by the client device, the second BSSID and the dynamic address in the data packet when the vendor-specific physical layer (PHY) extension is used.

20. One or more non-transitory computer-readable media containing, in any combination, computer program code that, when executed by operation of a computer system, performs operations comprising:
generating, by a client device, an obfuscated vendor identifier (ID) by applying one or more transformation functions to a real vendor ID;
generating, by the client device, an encrypted message, wherein the encrypted message comprises obfuscation data, which, when used, converts the obfuscated vendor ID into the real vendor ID;
transmitting, by the client device, the encrypted message to an access point (AP); and
transmitting, by the client device, a data packet containing the obfuscated vendor ID to the AP.
